(19) United States
(12) Patent Application Publication
(10) Pub. No.: US 2006/0015524 A1
(43) Pub. Date: Jan. 19, 2006

(54) System and method for creating and recreating image-based databases

(76) Inventors: Allan Gardiner, Kensington, CA (US); Kwoktai D. Tang, Concord, CA (US)

Correspondence Address: FLIESLER MEYER, LLP, FOUR EMBARCADERO CENTER, SUITE 400, SAN FRANCISCO, CA, 94111, US

(21) Appl. No.: 11/156,117

(22) Filed: Jun. 17, 2005

Related U.S. Application Data
(60) Provisional application No. 60/581,250, filed on Jun. 18, 2004.

(51) Int. Cl. G06F 17/00

(52) U.S. Cl. 707/102

(57) ABSTRACT

Embodiments of this invention include systems and methods for creating and using an image-based databases. Individual data files can be parsed and combined to form a new database, or to add data to an existing database, even when the original database has been destroyed or rendered inaccessible. A database can be generated or assembled by information located within the tags in headers of the data files. Since the information needed to create the database is contained within the tag of a header in the data file itself, the system is capable of adding data of a different format from the existing database records, or data that contains different fields, simply by parsing the data file. Furthermore the database and the data it contains is consistent with the data files used to create it. The result is a database methodology that is reliable, expandable, easily searched, and accurate. The database and associated methods have particular uses in the medical field, but may be used to store any type of data.

### CLAIM OF PRIORITY

This application claims priority to U.S. Provisional Patent Application No. 60/581,250, filed Jun. 18, 2004, incorporated herein fully by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention is related generally to software systems and particularly to systems and methods for generating, using and reconstructing image-based databases.

### BACKGROUND

Modem computing systems often utilize data bases for the storage of large amounts of data. This is of particular importance when the data must be modified or augmented on a regular basis. Desirable characteristics of any database system include that the database be reliable, expandable, easily searched, and accurate. Common examples of such database systems include Oracle's “9i” system, IBM's “DB2” database, and Microsoft's “Access” and “SQL Server” products.

In addition to storing data within the database itself, many databases act as indices to external data. For example, a database of employee records may include records for each employee, and within each record may include a link to an external photograph of the employee, or to some other external file. Taken together, this entire set of records and photographs may be considered a single database. In the field of medicine, databases are regularly used for a wide range of applications, such as the storage of patient data and records, accounting and billing records, and as medical information databases. A typical medical information database (for example the type used in a MEDLINE literature search mechanism or in an expert system) may contain thousands of records, each of which records may include or be associated with an image file, for example an image of the patient, or of their condition, or of a chart associated with them.

One of the problems with such databases is that data can become corrupted for any number of reasons. Additionally, data may at times be moved or copied from one system to another. New data maybe added or imported into the database, which at some times may have a slightly different format. A traditional database may have difficulties with these procedures since a traditional database relies on having the database framework or skeleton in place, and then slotting the data into that framework. Unusual or unexpected data formats can lead to the database having inaccurately indexed data. This data may then be overlooked during searches, which generally causes deterioration in the database consistency. The problem is particularly acute if the database fails completely. In this instance, even though the individual data files (for example the image files and charts described above) may still be available, the central framework of the database is lost. When this happens the database may have to be recreated from scratch. Unless a good recent backup exists then much information can be lost and in the worst case the database may never be fixable.

### SUMMARY

Aspects of the invention include software systems and methods for creating, using and recreating image-based databases. In certain embodiments, individual data files can be parsed and combined to form a new database, or new data can be added to an existing database, even when the original database has been destroyed, lost or otherwise inaccessible. In some embodiments, a database framework can be generated or augmented by information located within a data file. Since the information needed to create the framework is contained within the data file itself, the system is capable of adding data of a different format from the existing database records, or data that contains different fields, simply by parsing the data file. Furthermore, in some embodiments, the framework and the data it contains is consistent with the data files used to create it. In such embodiments, the result can be a database methodology that is reliable, expandable, easily searched, accurate and robust. The database and associated methods have particular use in the medical field, but may be used to store any type of data.

In some embodiments, a file has a header and at least one tag therein, the tag contains at least one element of the information contained in the file. An element can be, for example, a question, a question and answer pair, a portion of a photograph, a numerical value (e.g., temperature, nerve conduction velocity, frequency of an electromyograph signal) data table or other relevant information. Thus, the file as a whole, when printed or displayed, contains the entire contents of the file. Similarly, a tag within a header also contains one or more elements of the contents of the file. If the database becomes corrupted, the elements in the tags can be used to recreate the entire database. This is quite unlike the prior art databases, in which a header contains information about the file, but does not contain actual elements of the file. Thus, when a prior art database becomes corrupted and data from the database is lost or is not retrievable, it will not be possible to reconstruct the database, because the contents are lost. In embodiments of this invention however, data is present within the header, so the contents of the file are not lost.

In the context of a medical application, each data file may pertain to a patient, or some other portion of medical information. The data file may include a photograph, image, or chart, etc. together with information pertaining to that image. Such data files are commonly used and shared among medical institutions. In accordance with an embodiment of the present invention, these data files maybe quickly added or imported into the database, even though they may have a slightly different format, or contain heretofore unknown fields. During a parsing process any unusual or unexpected data formats are automatically added to the database framework. This can happen even when creating a complete new database, for example following a complete database failure. The newly created database is completely consistent with the data files that comprise it, and none of the original data files are lost.

### BRIEF DESCRIPTION OF THE FIGURES

FIG. 1 shows an overview of a workflow for creating an image-based database in accordance with an embodiment of the invention.

FIG. 2 shows a diagram of a system for creating an image-based database in accordance with an embodiment of the invention.

FIG. 3 shows an example of a data file in accordance with an embodiment of the invention.

FIG. 4 shows a flowchart of a process for creating an image-based database in accordance with an embodiment of the invention.

FIG. 5 shows a diagram of how an embodiment of an image-based database can be used with a medical application.

FIG. 6 shows a diagram of how an embodiment of an image-based database can be used with another medical application.

### DETAILED DESCRIPTION

The invention is related generally to software systems and particularly to systems and methods for creating, using, and recreating image-based databases. The invention is a solution to a frustratingly common problem—that of a system/database failure. In one instance an older UNIX-based thermal imaging system, for use in medical applications, had failed for some unknown reason. The system included a database that pointed, using identification numbers, to various files and images stored on the computer. While the files were saved to a removable media, the ability to recover data after the failure was essentially lost because the database's proprietary file format could not be copied by standard file transfer programs. The magneto optic drives that stored the files could only be re-attached to a system substantially identical to the one that had created them. A compatible UNIX-based system was located to read the images, however some of the removable media was damaged and many images were lost completely. Another imaging system from a different manufacturer was employed, but this system also used a proprietary file format, which could not be opened by other imaging programs. When such systems are eventually replaced, the images taken on that system become unavailable for any future use. The type of problem described maybe found in other systems than UNIX based systems. In fact, any system that relies upon external pointers to link date files is subject to failure or reduced function if the pointer or a necessary file becomes corrupted.

In accordance with embodiments of the present invention, systems and methods for creating, using and recreating image-based databases are provided, which address the above-described problems as well as others. Individual data files can be parsed and combined to create a new database, or data can be added to an existing database, even when the original database has been destroyed. A database framework is generated or augmented by information located within a data file. Since information needed to create the framework is contained within the data file itself, the system is capable of adding data of a different format from the existing database records, or data that contains different fields, simply by parsing the data file. Furthermore the framework and the data it contains is completely consistent with the data files used to create it. The result is a database methodology that is reliable, expandable, easily searched, and accurate. The database and associated methods have particular use in the medical field, but may be used to store any type of data.

In the context of a medical application, each data file may pertain to a patient, or some other portion of medical information. The data file may include a photograph, image, data, or chart, etc. together with information pertaining to that image, data etc. Such data files are commonly used and shared among medical institutions and different work-stations. In accordance with an embodiment of the present invention, these data files maybe quickly added or imported into the database, even though they may have a different format, or contain unknown fields. During a parsing process any unusual or unexpected data formats can be automatically added to the database framework. This can happen even when creating a complete new database, for example following a complete database failure. The newly created database can be completely consistent with the data files that comprise it, so that none of the original data files are lost. This is important for secondary databases as well as for medical databases because of the requirement for archived and retrievable data for a statutory period of time.

A database may also include a collection of smaller databases that maybe distributed by any means known in the art or described herein. Databases maybe linked in a heirarchial mode or they may be linked by tags in an image. Linking by tags can provide a wide connectivity that does not require a master database for its cohesion. In prior art databases, after a path is broken, connectivity is lost with some or all of the data in another database. Thus, reassembly of a combined database maybe impossible. For data that is intended to not be lost, such as specifically related data, placing the data in tags can provide an additional backup, from which the original database can be recreated without the need for a link to an external database.

The term “metadata” also known as “ag”, as used herein, includes information included in a specific location in a file header. A tag maybe a “comma-separated variable,” or “pair-value” whereby numerous pieces of information maybe included, such as location coordinates, text information, file dates and the like. Additionally, “pair-value” tags can include both a question and its answer. Thus, a search of a question can produce a result containing an answer. Such answer may be inserted into a tag.

For example, an electronic media based medical questionnaire is answered by a researcher or by a subject. Each “screen” consists of one, or many, questions with associated possible answers available for selection, or a means of answering by means of text entry. Each answer is displayed on the screen for review before it is “submitted” to the database. Submission data, such as time-stamps, are also placed in the data file header. The record of the data is preserved by creating a PNG file having a “screen capture” image, optionally watermarked or otherwise integrity protected, as the “image” portion of the file and having the question:answer pair or pairs placed as tags within the header portion of the file. The image file contains as much other tagged information about the subject, such as id, age, sex, infirmity, etc., as maybe practically available for automated reconstruction of the database.

The redundancy of tagged data that is within the “image” permits full audit capability of the images within the reconstructed database. A human auditor may compare the tagged data with the same data as imaged in the “screen capture” to provide a high degree of certainty that the intended answers were properly recorded and entered into the restored database. Additionally, optical character recognition can be used to compare image content with content within the tags. Further, in still other embodiments, tags from an original database can be compared to tags of a reconstructed database.

In other embodiments, encrypted codes can be included in the tags or image which make the tagged data and image data tamper-evident.

Balloting is another example where the methods of this inventions maybe used to preserve the ability to reconstruct a large database with easily auditable, protected data and images. The “screen capture” image represents the “paper” image and the tagged data confirms the content of the image and permits automatic database reconstruction.

Auditing of a reconstructed database may also be accomplished by comparison with the original database created at the time the data was originally “submitted” as questions with answers. Comparison of time stamps or revision numbers within the tagged data may be used to improve the reliability of the audit.

Data File Formats

Within any collection of images or data files, a significant loss of information can occur when the images or files become disassociated with the database. This can happen whenever a database is corrupted and pointers connecting the database to the images are lost. Traditionally, the name of the file is one variable that is used to store information about an image for ease of retrieval. This can pose problems because of the risk of simply renaming the file, which would destroy the information originally attributed to that image. In accordance with an embodiment of the invention the use of headers within a data file can eliminate the problem caused by changed file names, since the file name itself no longer carries any vital information. Thus, the file name maybe identified for human convenience, or may be an original file name.

In accordance with an embodiment of the invention, an extensible file format such as the Portable Network Graphics (PNG) file format can be modified to include headers (tags) that describe as much database information as is known about the patient or content of image data at the time that the file was created (or in the case of an image when the image was taken). Such information, files, and images maybe received, for example, from a Photographic Medical System (herein a “PMS” system). A PMS system can include modules that make thermal imaging, data logging, medical information, and treatment information available to each other on a real-time basis. All the information can be patient ID protected through the use of generated ID numbers. In accordance with an embodiment of this invention, data file headers are used to retain information about the data, such as the original filename, ID, sex, age, diagnosis, most recent treatment, dated timestamp, body parts in image, and angle of view. Additionally, numerical valuses of data images such as questionnaires, or visual analog scale use for patient description of pain symptoms (“VAS”), electronic signature information or authentication and the like. It can be appreciated that other types of data can also be included.

The PNG format is readable by most commonly available computers using a PNG reader application. The tags that are not coded in such a fashion to be understood by the PNG reader are simply not displayed. Therefore, portions of data or images can be protected from view by a casual observer. Many standard PNG readers can read the header so that information is not lost, especially the date timestamp. The PNG format is highly compressed, but lossless, making it an efficient means of storing images of data collection forms. The PNG format is also a public domain data format, which has no royalty fee associated to it. It will be evident that other data formats could be used as long as they include headers to capture as much data as possible.

In accordance with an embodiment of the invention, the recreation process is one that includes reading one or more tags within each file, and building a database. Each time a new tag is encountered, a new item can be included in the database. Backwards compatibility is assured because all of the fields in old images are included in a new database. Only data contained in the image or known when the image or file was produced needs to be in the tags. Each image file need have only the appropriate data. The database generator automatically detects new fields and expands the database. This means that a collection of images (or other tagged files) can be grouped together and the database automatically created for those images.

One can build tags using PNG, CSV, metadata (.wmv files), data logging files or other systems. An image in the system can be reassembled in different ways by creating groups based on certain tags. For example, the total collection of images, or a subset of those images, can be searched for images having a particular tag value, such as a diagnosis of diabetic neuropathy or other diagnosed condition, the type of treatment applied, the location of treatment or other desired characteristic, without the requirement of having the complete database. This is useful when, for example, a separate study of images based on a particular parameter is to be carried out. A database assembly method can process any group of images retrieved from a removable media to be re identified as to the ID and date timestamp of the person in that image. Inclusion of the original filename as a tag permits the original filename to be restored in the event that the filename has been changed.

No previous knowledge of the file is required because every file has the information tagged. For example, a question and answer can both be tagged and associated with each other to permit automatic assembly of a database containing such question and answer pairs.

Although the above discussion focuses on image files, data logging files can similarly be provided with a header that contains the same tags as the .PNG files. The database generator software can then provide all of the same protections for the logged files as it does for images.

File Types

Moving Images or Sequential Images:

Industrial standard files, such .wmv for Windows Media 9, permit metadata tags for defined purposes. The tags maybe extended for data that is not used directly by and is ignored by the software player. The standard tags include elements such as the screen size, creation date and author. The files can be searched for tags in the header for specific extended data such as the type of images, photographic, angiographic, or thermal imaging, as well as the body part being imaged as well as the patient ID. Metadata, sometimes called pair value data, includes the question and the associated answer for each item. The database reconstruction program identifies new questions and adds them to the database automatically.

Logged Data from a Variety of Sources:

Comma Separated Variable or “CSV” files are commonly used by spreadsheet programs, for example Microsoft Excel. The files generally contain data values taken at specific intervals for one or several devices or parameters. Special tags permit construction of tables and graphs using data once it has been transferred into the spreadsheet environment.

Metadata tags may be placed before the collected data. The tags may be used for recreating an image-based database or for other purposes as described for the PNG files. The database reconstruction program identifies the tags and adds the data to the database associated with the tag. New database items may be added when they are detected by a reconstruction program.

Data Output and Transmission

In general, output can be to any type of visual display device, a memory device or maybe transmitted remotely. For example, a visual display device maybe computer monitor, television receiver, holographic displays, oscilloscope, print, such as data traces, charts, graphs and the like. Additionally, output maybe via auditory means, through speakers, headphones, electronic signals and the like. Transmission can be byway of cable, fiber optic, satellite, microwave, radio waves and the like. Electronic communications maybe via intranet, local area network, internet, wifi and other types of networking systems.

For example, in medical applications, the patients identifying data such as their name must be removed before transmission. The data maybe collected without the identifying data and the complete database reconstructed by using protected data being contained in files that have been managed separately for privacy or security.

Validating a Reconstructed Database

Other aspects of this invention include means for validating the completeness of a reconstructed database. It can be appreciated that a user might desire to know whether a reconstituted database is sufficiently complete to be useable, or whether the reconstructed database is so corrupted as to be discarded. In some embodiments, such validation can be accomplished using tags inserted into the original image. For example, names of associated images or a position of a specific image within a series of images can be included as tags within the original file. Such information may be considered, for purposes of general understanding to include “page 1 of 6.”

In other examples, data that night be considered redundant can be desirably included in tags in an image file to increase the likelihood of a complete reconstruction of a database. Such information could include patient age, sex, diagnostic code, patient identifying information (e.g., name, ID number, etc.).

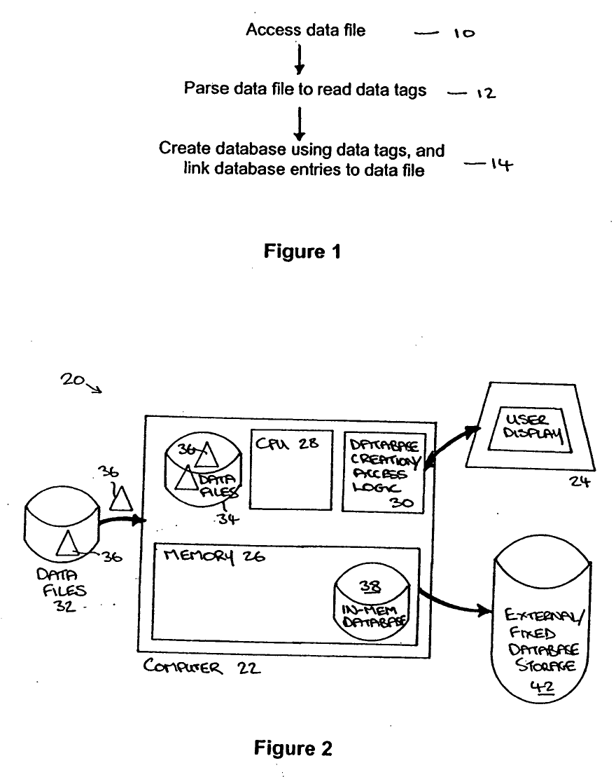

FIG. 1 shows an overview of a workflow for creating an image-based database in accordance with an embodiment of the invention. As shown in FIG. 1, instep 10, a data file, for example a medical image file stored in PNG or an equivalent format, is accessed. In step 12, the data file is parsed to read the data tags stored in the file header. In step 14, a database is created using the data tags read from each data file, and optionally each entry in the database is linked to its corresponding data file, for example an image file. In this manner the database represents all of the data files read in, and is completely consistent with those data files.

FIG. 2 shows a diagram of a system for creating an image-based database in accordance with an embodiment of the invention. As shown in FIG. 2, the system includes a computer 22 or similar computing device. The computer may comprise or be a component of a medical imaging system, data acquisition system or other type of system. A user display 24 allows a user to access the system and to view, modify data etc. The system also includes a memory 26 for temporary storage of data and computer commands, a processor or CPU 28 for performing operations, and a database creation logic 30 in accordance with the invention for use in creating databases. Data files 36 maybe read into the system either from an external removable medium 32 such as a diskette, or from an internal medium 34 such as a fixed disk drive connected with the system. As the data files are read in, the database creation logic is used to parse the tags within each file and to create the corresponding database. The database maybe created on-the-fly within the memory 38 of the system, which may be efficient for quick searches among multiple data files, and optionally may be stored to an external fixed disk for permanent storage 42 and subsequent retrieval or a removable medium such as an optical disk and the like.

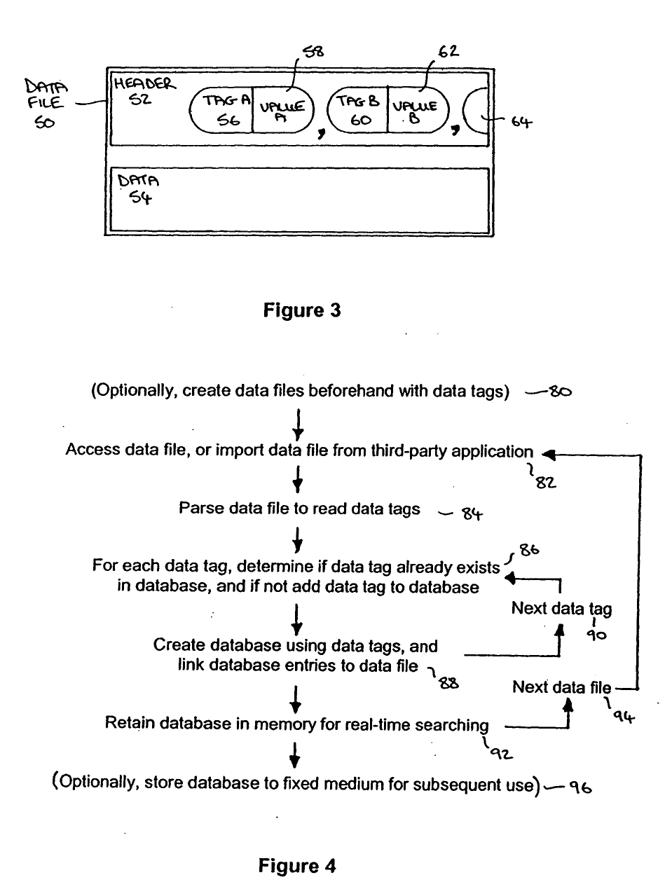

FIG. 3 shows an example of a data file in accordance with an embodiment of the invention. As shown in FIG. 3, the data file 50, such as a PNG format image file or an equivalent data file, includes a header portion 52 and a data portion 54. The data portion 54 typically contains an image. The header portion includes any number of tag:value pairs 58,62,64. Each tag:value pair includes a tag identifier 56, 60 and a corresponding tag values 58, 62. As the database is created, the system reads each data file, and parses the header of each file to determine which tags are present. New tags are automatically added to the database, so that the database automatically“learns” or ressembles itself using the information in each data file. Examples of tag identifiers include the original filename, a patient ID, sex, age, diagnosis, most recent treatment, dated timestamp, body parts in image, angle of view questionnaires and questions and answers. Tag values are the corresponding value associated with each tag identifier, for that particular data file or image. Not all tag identifiers in every image will have a value associated with them, since in some instances this particular item of information maybe missing from the data file. A value pair maybe left out of the tagging or a null value maybe used. A database generator maybe designed to handle these and any other case.

FIG. 4 shows a flowchart of a process for creating an image-based database in accordance with an embodiment of the invention. As shown in FIG. 4, in step 80, which is an optional step, data files are created beforehand, together with appropriate data tags. Optical character recognition systems may be used to locate data within an image, which can be converted to tags by appropriate software. In other instances, the process can be used to retrieve data files and images from other systems, in which case the data files may have been created by another entity or another process using the same tagging process. New files with tags may be created manually by a technician who enters data seen in the image for the image maker to include tags. For example, images within a patient's file need to be converted from paper to digital, a file creation program can be used to scan or capture the paper image and to apply the data tags. In step 82, each data file is accessed, by for example reading from disk or diskette, or by importing the data file from third-party application. If desired, an operator may then review the file and tag available information from an image to create a new compatible file. In some embodiments, an optical character recognition system can be used to locate data within an image that can be converted to tags by appropriate software. In step 84, the data file is parsed to read the data tags in the file header. In step 86, for each data tag in the header, the system determines if the data tag already exists as an option in the database, and if not then the data tag is added to the database as a new database field. In this manner the database can be automatically assembled using the information in each data file. In step 88, the database is created using the data tags, and database entries are linked to their corresponding data or image file. The process then continues in step 90 for the next data file. In step 92, the database thus created may be retained in memory for real-time or occasional searching through the data files that have been read in. This process then continues in step 94 for each of the remaining data files. In step 96, which is an optional step, the database may be stored to a fixed or removable medium for subsequent retrieval and use. Alternatively, the database may be stored in a removable medium for distribution or archiving.

Additional Uses for Image-Based Databases

Wanted Poster

In addition to the uses described above, numerous other applications of image-based databases are possible. For example, a “Wanted Poster” maybe created for law enforcement, security or other purposes. Traditional methods of disseminating such information would include a fax of a photograph or drawing, telephonic or other text communication, which would then be reassembled by persons receiving such information. According to aspects of this invention, an image-based database can include an image file (e.g., containing a photograph or drawing) with context-specific text included to create an overlay image, having all the relevant information contained in a single file for transmission and use. In other applications, the overlay image can be updated automatically with the input of other file types so long as they have compatible tags within them. Thus, iterations of such files can be made with greater ease, speed and reliability. Further, backwards compatibility is inherent within certain aspects of the systems.

Questionnaire with Screen Capture

In another embodiment, an electronic media based medical questionnaire is answered by a researcher or by a subject. Each “screen” consists of one or more questions with associated possible answers available for selection, or a means of answering by means of text entry. Each answer is displayed on the screen or other output device for review before it is “submitted” to the database. Submission data, such as time-stamps, are also placed in the datafile header. The record of the data is preserved bt creating a PNG file having a “screen capture” image, optionally watermarked or otherwise integrity protected, as the “image” portion of the file and having the question:answer pair or pairs placed as tags within the header portion of the file.

The image file contains as much other tagged information about the subject, such as identification number, age, sex, diagnosis or infirmity, and the like, as maybe practically available for automated reconstruction of the database. The redundancy of tagged data that is within the “image” permits full audit capability of the images within the reconstructed database. A human auditor may compare the tagged data with the same data as imaged in the “screen capture” to provide a high degree of certainty that the intended answers were properly recorded and entered into the restored database. Optionally, encrypted codes can be included in the tags or image, which make the tagged data and image data tamper-evident.

Balloting is another example where methods of this invention can be used to preserve the ability to reconstruct a large database with easily auditable, protected data and images. A “screen capture” image represents or is equivalent a “paper” image, and the tagged data can confirm the content of the image and can permit automatic database reconstruction. Such reconstruction with auditing can permit validation of results of balloting, in for example political processes.

Auditing a reconstructed database may also be accomplished by comparison with the original database created at the time the data was originally“submitted” as questions with answers. Comparison of time stamps or revision numbers within the tagged data maybe used to improve the reliability of an audit.

Automatic Translation of Text Information

In other aspects, files can be created containing context-specific text that can be associated with a language translator. In such embodiments, text may be created in one language (e.g., English), and then a user may receive the file and desire the text to be displayed in another language. Such displays may be created by translations initiated by the user, for example, by pressing a “select language” button, which may include software.

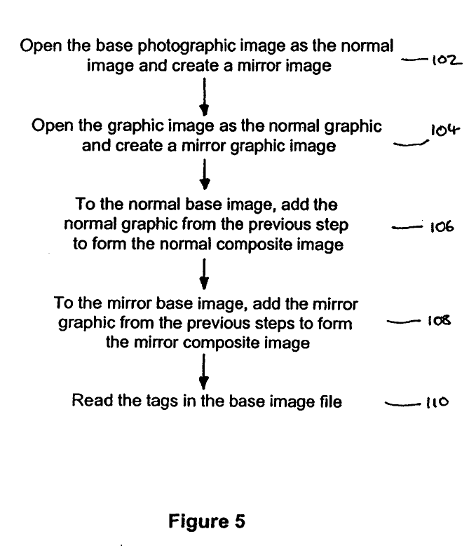

FIG. 5 shows a diagram of how an image-based database can be used with a medical application in accordance with an embodiment of the invention. As shown in FIG. 5, described in more detail below, a base photographic image with an overlay of graphic and text information, wherein the text may be included as tags. One or more overlays are selected by the user while interacting with a data/image delivery software module. The traditional method uses a database which has links to the individual images and graphics element, and which then assembles the layers selected for display. However, with these traditional methods a problem occurs when the database gets corrupted and the links are lost, or when new elements are added without correspondingly updating the database. In accordance with an embodiment, the XML language and PNG format images are designed to link images and data contained within the page or file.

By way of example, in a medical context a photograph of a hand is associated with graphic layers showing the nerves terminating within the view. Another associated layer showing the electrodiagnostic points can be substituted when the display image is produced. The layering can be affected by selections made by the user at some time before the image is constructed. The images are generally used for the image included, and the tags are used for size and other information needed by the assembly software. Medical illustration is complicated by the requirement for showing right and left side details that are not unique to either side. A collection of images, graphics, and text is nearly doubled in size if separate, but nearly identical, images are used for both sides. An easy, partial, solution is to flip the images and overlays to create the second side from the images and graphics collected for the first side. Unfortunately, textual information does not flip and yet still maintain its readability, so this traditionally requires two text image files. The files have to be created and maintained, as well as linked to the base image. Maintenance of the file organization at the database level is also required. Layers maybe used in place of separate files, but at a minimum, 2 layers are required for the normal and mirror text.

In accordance with an embodiment, the text information and locations of the text for both the left and right sides is placed in the tags for each image. The text to be added to the images during assembly for display is selected for the proper hand at assembly time by selecting the tags appropriate to the hand of the base image. Each image contains tags with each text element and the location of the text for each hand along with the photographic and graphic layer. The image portion of the file maybe reversed (mirrored) while the text is actually placed according to the tags. The text inclusion eliminates a doubling of the images required to satisfy the right/left presentation of near duplicate information.

FIG. 5 illustrates the above process as applied to an example of a medical image, to combine one image and one graphic layer with text to produce a normal and a mirror image. In step 102, a base photographic image is opened as the normal image, and a mirror image is created. In step 104, a graphic image is opened as the normal graphic and a mirror graphic image is created. The typical graphic image is transparent such that any number of layers maybe stacked on the base image. In step 106, the normal graphic from step 104 is added to the normal base image, to form the normal composite image. In step 108, the mirror graphic from step 104 is added to the mirror base image, to form the mirror composite image. In step 110, tags are read in the base image file. For the normal image, the appropriate text tags and location tags are taken and the text is applied to the normal composite image at the locations specified in the tags for the normal composite image created in step 104. This process is repeated for each layer that is to be combined. The text will then read correctly.

Note that the text or graphics from one layer could interfere with text or graphics from another layer. In certain embodiments such interference can be resolved by using color to distinguish the text from graphic information. Alternatively, text conflicts could be resolved by calculating the space occupied by the text for each layer and moving text by simple rules. Good text locating positions should be determined when the images, graphics, and text composites are designed, to maintain clarity for all combinations.

Mirroring Images

An image may contain calculated data such as average temperature of a region of interest. Existing programs use tags to describe the region of interest and the calculation to make or the calculated data as well as rules for placing the data in the resulting image. The tags permit the region of interest and calculations to be changed when the image is viewed using compatible software.

One embodiment of this invention permits the mirror presentation with one or multiple overlays along with the text applied to the desired location. The tags are also used for an image-based database. In another embodiment, text locations for the normal and mirror images maybe specified in tags or can be computed for a mirror image.

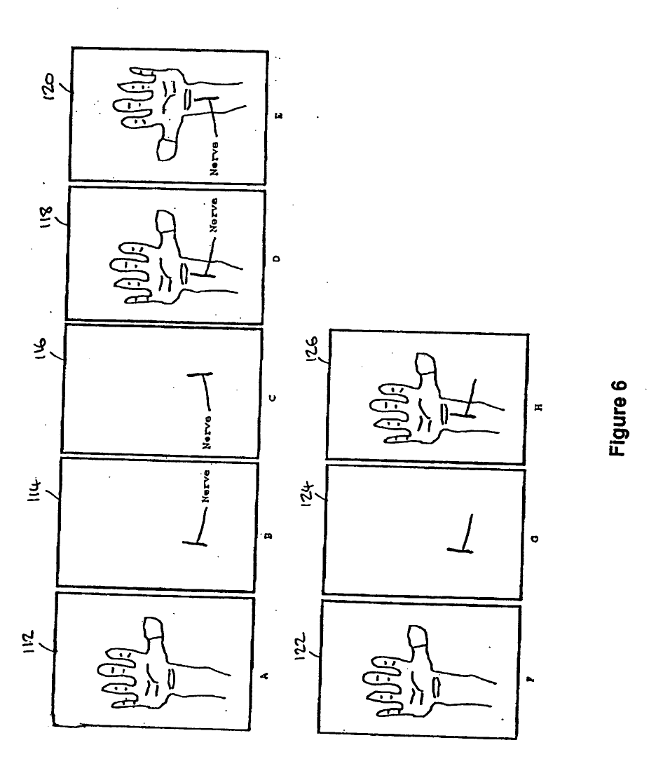

FIG. 6 shows a diagram of how an image-based database can be used with another medical application, for example, for construction of images relating to nerve effects. As shown in FIG. 6, image A 112 is the “base image” which is presumed to be a large file size because of the necessary color and resolution. Image B 114 is the first “layer” image which is presumed to be a small file size because of low detail and compression. Image C 116 is the first “layer” mirror image. Image D 118 is the desired final image for the first layer with text. Image E 120 is the desired final mirrored image for the first layer with text. Image F 122 is the proposed base image. Image G 124 is the proposed layer image with tagged text. The desired results are shown in D and E for a base image, single layer and text. Examples of methods using such images are described below.

Method 1: make two images with all of the details in each. Large files are often required. Multiple layers with small changes require numerous large images. The number of images equals the final number of images to be presented. Five layers for normal and mirrored presentation require ten full file size images.

Method 2: Make one base image with as much detail as required which is mirrored for the mirror presentation. Additional, smaller file size graphic plus text layer are prepared for the normal and mirrored presentations. File space is smaller than Method 1 because the layers are smaller.

The typical method for producing such mirror images with non-mirror text combines 3 images (D=A+B and E=Aₘᵢᵣᵣₒᵣ+C). For each additional graphic layer to be combined with a base layer, two additional images are required. The total images equation is:
Images=Base+2×Number of Layers
(Thus 5 layers would require 11 images). In accordance with an embodiment, alternate methods can be used:

Method 3: For a single layer image, combine the base and graphic images Image H and place the text in the tagged portion of the PNG image along with a tag for the XY location of the starting point for the text. Each text element is handled by incorporation of text and location tags. Create the standard image D by placing the text at the proper location. Create the mirrored image by combining the mirrored base image and the mirrored text placed the text appropriately by calculating the complementary text starting location. One image is required to produce the two images.

Method 4: For any layer in a multiple layered images, combine the base image F along with its text as in Method 3 and the desired layer image G. Image G contains the text appropriate to the desired layer. The mirrored image is created by repeating Method 3 for the Base image and repeating Method 3 using the layer image. The file space for the images is reduced as compared with the traditional methods:
Images=Base+Number of layers+tags
(Thus 5 layers would require 6 images).

The present invention may be conveniently implemented using a conventional general purpose or a specialized digital computer or microprocessor programmed according to the teachings of the present disclosure and a storage device. Appropriate software coding can readily be prepared by skilled programmers based on the teachings of the present disclosure, as will be apparent to those skilled in the software art.

In some embodiments, the present invention includes a computer program product which is a storage medium (media) having instructions stored thereon/in which can be used to program a computer to perform any of the processes of the present invention. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Overlay Images

In other embodiments, an overlay image can be created using information in tags in a database. In some of these embodiments, a graphic image containing a photograph or diagram can have identifiers inserted at selected places for display purposes. For example, a photograph of a body part may have context-specific text overlaid thereon to identify by name, the part to be discussed. Specifically, for example, the word “nerve” can be inserted in an image file to display that word over a nerve. More specifically, by example only, the terms “median nerve” or “ulnar nerve” may be placed over an image of an arm. It can be appreciated that the location of placement of such context-specific text can be done using methods, devices and software known in the art, including, for example, Euclidian coordinates based on reference points within the image file. The context-specific text may be selected by the user upon creation of the image file, or may be selected automatically by image analysis software that uses the image and knowledge of features within that image to identify them by, for example, absolute or relative location, size, temperature or other identifying characteristics.

Traditional methods for accomplishing related tasks include mark-up languages, such as html.

By placing tags identifying such structures within a overlay image file, then, even if the original image file or text files are lost, the combined, overlay image file may be recreated.

The foregoing description of the present invention has been provided for the purposes of illustration and description only. It is not intended to be exhaustive or to limit the invention to the precise forms disclosed. Many modifications and variations will be apparent to the practitioner skilled in the art. The embodiments were chosen and described in order to illustrate the principles of the invention and its practical application, thereby enabling others skilled in the art to understand the invention for various embodiments and with various modifications that are suited to the particular use contemplated.

### INDUSTRIAL APPLICABILITY

The invention provides a system and method for creating and using image-based databases for use in any computer related industry, including the medical industry. Individual data files can be parsed and combined to form a new database, or to add data to an existing database, even when the original database has been destroyed. The database and associated methods have particular use in the medical field, but may be used to store any type of data.

I claim:

1. A system that includes an image-based database, comprising:
a plurality of data files, wherein each data file includes:
an image;
a header; and
at least one tag therein including at least one element of said image;
a database assembly logic which is adapted to:
receive each of said plurality of data files;
parse the headers to create or update a database; and
wherein upon detecting a previously unknown tag in a data file, the database assembly logic is adapted to:
add the tag to the database as an available database field; and then
update the content of the database with the contents of the data file.

2. The system of claim 1, wherein a data file is a portable network graphics format file.

3. The system of claim 1, wherein at least one of said image files includes at least one element of a subject's record.

4. The system of claim 3, wherein said record is a medical record.

5. The system of claim 4, wherein descriptive information about the image is stored within at least one tag.

6. The system of claim 1, wherein at least one of said data files includes:
at least one element of a subject's medical record; and
an image pertaining to said subject's medical record; and wherein
descriptive information about said element or image is stored in said tag.

7. The system of claim 1, wherein at least one of said tags is adapted to be modified or augmented to include a new type of data for storage in the database.

8. The system of claim 1, wherein the database is retained in memory.

9. The system of claim 1, wherein the database is saved to a storage medium.

10. The system of claim 1, wherein each entry in the database is linked to a corresponding data file.

11. A system including an image-based database, comprising:
a computer having:
a processor, a memory for temporary storage of data, computer commands, and a database;
a plurality of data files, including:
a header within each file; and
tags therein defining elements of data contained within the data file; and
a database creation logic, which is adapted to:
receive each data file of said plurality of data files; and
parse the headers to create or update the database; and
wherein upon detecting a previously unknown tag the database assembly logic adds the tag to the database as an available database field.

12. The system of claim 11, wherein the database is created in real time.

13. The system of claim 1 1, wherein said data file is read into the system from an external medium.

14. The system of claim 11, wherein the database is stored in an external medium.

15. A method for assembling a database, comprising the steps of:
accessing at least one data file having at least one database entry therein;
parsing said at least one data file to read at least one data tag in a file header of said data file;
determining whether the data tag already exists as in the database, and if not, then adding the data tag to the database as a new database field or entry in said field;
creating or updating the database using said data tag;
linking the database entries to corresponding data or image files; and
storing the database.

16. The method of claim 15, wherein said data file is accessed from a disk, diskette or is imported from a remote location.

17. The method of claim 16, wherein said step of importing includes importing via a local area network, internet or satellite system.

18. A method of overlaying text and graphic data from images, comprising the steps of:
(a) opening a photographic image as a normal base image file;
(b) creating a mirror base image of said normal base image;
(c) opening a graphic image including multiple layers as a normal graphic;
(d) creating a mirror graphic image;
(e) adding said normal graphic to said normal base image to form a normal composite image;
(f) adding a mirror graphic to said mirror base image, to form a mirror composite image;
(g) reading one or more tags in said base image file;
(h) for said normal image, applying the appropriate text tags and location tags to said normal composite image at locations specified for said normal composite image; and
(i) repeating the steps (a)-(h) for each layer that is to be combined, thereby producing a combined graphic and text image.

19. The method of claim 18, wherein said mirror graphic includes at least one tag at a location based on an additional tag.

20. The method of claim 18, wherein said text image has a size and/or location based on at least one calculation using the size of the text as a variable in said calculation.

21. A computer readable medium, comprising:
a database comprising one or more data files, each of which comprises at least a portion of an image, each of said files containing:
a header; and
at least one tag therein defining at least one element of data contained within the data file.

22. A method for reconstructing a database, comprising:
accessing a graphic image file;
overlaying on said graphic image file, textual information obtained from at least one header from the graphic image file, and wherein said image and textual information are adapted to be displayed or transmitted.

23. The method of claim 22, wherein said textual information is selected from the group consisting of photographs, data tables and labels.
